(19) United States
(12) Patent Application Publication
(10) Pub. No.: US 2025/0349939 A1
(43) Pub. Date: Nov. 13, 2025

(54) DEVICE FOR PROTECTING AGAINST THE PROPAGATION OF THERMAL RUNAWAY IN A BATTERY

(71) Applicant: SAFT, Levallois-Perret (FR)

(72) Inventors: Sébastien PHILIPPE, SAINT JEAN D'ILLAC (FR); Florian AUGUIN, SALLES (FR); Matthieu BERTIN, VILLENAVE D'ORMON (FR); Laurent POUYAU, BLANQUEFORT (FR); Christophe DOS REIS, BLANQUEFORT (FR)

(73) Assignee: SAFT, Levallois-Perret (FR)

(21) Appl. No.: 18/868,222

(22) PCT Filed: May 17, 2023
(86) PCT No.: PCT/EP2023/063246

§ 371 Date: Nov. 22, 2024

(30) Foreign Application Priority Data
May 24, 2022 (FR) FR2204993

(51) Int. Cl. H01M 10/658; H01M 10/04; H01M 10/647; H01M 50/209; H01M 50/293

(52) U.S. Cl. CPC H01M 10/658; H01M 10/0481; H01M 10/647; H01M 50/209; H01M 50/293

(57) ABSTRACT

A battery including at least two electrochemical cells of parallelepiped format; a first layer of a refractory material able to withstand a temperature up to 1200° C. placed in contact with the entirety of a first face which is one of the faces of largest area of one of the electrochemical cells, the first layer including a central region having as its center the center of the first layer and having an area representing 30 to 60% of the area of said first face; and a rigid spacer having a hardness greater than or equal to 90 Shore A according to standard ASTM D 2240-15, placed between said first layer and the second electrochemical cell (2-2), the rigid spacer being located outside of the central region of said first layer.

### TECHNICAL FIELD OF THE INVENTION

The invention relates to the technical field of devices for protection against the propagation of thermal runaway in a battery with electrochemical cells.

### BACKGROUND OF THE INVENTION

A battery with electrochemical cells comprises a plurality of electrochemical cells, designated in the following by the term “cell(s)”, which are assembled side-by-side in a common grouping box. This box is intended to hold the cells fixed in position during transport or use of the battery.

During charging of a lithium-ion hermetic cell, a swelling of the container of the cell is observed. In the case of a cell of parallelepiped format (synonymous with prismatic format), the swelling is produced substantially on the two largest opposite flat side faces of the container. This swelling increases gradually as the charge state of the cell approaches the fully charged state. Since the cells are attached one behind the other in the grouping box and each cell undergoes an increase in its thickness, a significant increase in the total length of the battery is observed, which results from the sum of the increases in the thicknesses of the cells. However, since the grouping box is generally composed of a rigid material and the free space between the cells and the walls of the box is limited, the swelling of the cells subjects the walls of the box to pressure forces which can lead to its irreversible deformation, or even to its damage. Consequently, a device is often used to prevent the box from deforming under the effect of the swelling of the cells during charging.

Furthermore, an anomaly in the operation of the battery can be caused by the malfunction of one of the cells (short-circuit, overload, etc.) or by an external disturbance (impact, rise in temperature, etc.) or else by a failure of the electronic system managing the charge state or other parameters of the battery cells.

For example, when a lithium cell is subjected to an overload, its temperature increases. The increase in temperature leads to an increase in the charging current which further promotes the increase in temperature. If the cell does not have a sufficient cooling system in order to remove the emitted heat, this results in a situation of thermal runaway: the increase in temperature is fed by the cell itself. The uncontrolled increase in the temperature of the cell leads to the generation of gas, which can lead to an increase in the internal pressure of the cell, which will open a gas evacuation system. When hot gases are released, the temperature of which can reach 650° C., these gases come into contact with other battery cells. There is then a risk that the phenomenon of thermal runaway propagates through the assembly of battery cells, leading to the total destruction of the battery.

A device is therefore sought which prevents the box from deforming under the effect of the swelling of the cells during their charging and which also prevents the propagation of thermal runaway between the battery cells.

Document EP-A-3 208 866 describes a system for compensating the swelling of cells in a battery. This system comprises a rigid spacer and a flexible spacer inserted between two neighboring cells. The rigid spacer can be disposed at the periphery of the largest face of the cells. Its function is to keep constant the distance between the two neighboring cells. The flexible spacer can be disposed in the vicinity of the center of the largest face of the cells. Its function is to absorb the increase in thickness of the two cells during their charging. As shown in FIG. 2b of that document, this system makes it possible to maintain a constant length of the battery in the event of swelling of the cells. In a preferred embodiment, the flexible spacer is composed of a material having a low thermal conductivity. This has the advantage of preventing the heat generated by this cell from propagating to the neighboring cells. In order to improve safety, there is a need for the inter-cell spacer to withstand very high temperatures.

Document EP-A-2 994 947 describes a battery comprising a first and a second prismatic cell, between which is disposed a layer of a material able to withstand a temperature of 300° C. This material is not in contact with the entire surface of the outer wall of the container of the two cells. Indeed, two separators placed between the containers of the two cells in their high and low portion keep the material able to withstand a temperature of 300° C. at a certain distance from the wall of the container of the cells. The association of the layer of material able to withstand a temperature of 300° C. and two separators is presented as constituting a thermal barrier against the propagation of thermal runaway. However, this solution is not totally satisfactory because it is noted that the layer of material able to withstand a temperature of 300° C. is not in contact with the wall of the container of the cells. There are two layers of air on either side of the layer of material able to withstand a temperature of 300° C. On the one hand, these layers of air can facilitate the propagation of heat to the neighboring cells. On the other hand, they increase the length of the battery. The fact that the material able to withstand a temperature of 300° C. is not in contact with the entire surface of the cells does not allow the thermal barrier property of this material to be fully exploited. Moreover, when the cells swell, the layer of the material able to withstand a temperature of 300° C. has a tendency to be crushed under the effect of the compression force exerted by the cells. It therefore fulfils its role as an insulator less well. Finally, it is recommended to use separators having a certain flexibility in order to match the shape of the surface of the cells. Since the layer of the material able to withstand a temperature of 300° C. and the separators have a tendency to be crushed under the effect of the compression of the cells, the separation between the terminals of the two neighboring cells decreases. The electrical connection between two neighboring cells must therefore be flexible in order to absorb the variation in the inter-cell distance. However, such flexible connections are by design more complex than rigid connections in the form of simple metal strips.

Document U.S. Pat. No. 9,324,982 describes a system for compensating the swelling of the cells in a battery and ensuring their cooling. A barrier is disposed between two cells. It is composed of an outer part in contact with the periphery of the face of largest area of the cells and an inner part in contact with the center of the face of largest area of the cells. The outer part is rigid and maintains a constant spacing between two neighboring cells. The inner part is flexible and absorbs the increase in volume of the two neighboring cells. The opposite faces of the outer part and the inner part are covered with spikes having a truncated pyramid shape. The cooling of the cells is ensured by the circulation of air between the spikes. The disadvantage of the spikes is that they increase the length of the battery. The presence of air circulation corridors is no longer desirable, because they can contribute to the propagation of the thermal runaway. Moreover, the box of the battery must be provided with openings in order to allow the entry and exit of the air. Finally, the contact surface between an cell and the barrier is relatively reduced since it is limited to the truncated upper surface of the spikes. As for the preceding document, this system for compensating the swelling of cells makes it possible to reduce propagation of heat in the battery when this is used under nominal operating conditions. It is, however, not designed to prevent the propagation of thermal runaway from one cell to a neighboring cell.

Therefore, there remains a need for a system for compensating the swelling of cells, which can also avoid the propagation of thermal runaway between the cells.

### SUMMARY OF THE INVENTION

For this purpose, the invention proposes a battery comprising:
at least two electrochemical cells of parallelepiped format,
a first layer of a refractory material able to withstand a temperature up to 1200° C., disposed in contact with the entirety of a first face which is one of the faces of largest area of one of the electrochemical cells, said first layer comprising a central region having as its center the center of the first layer and having an area representing 30 to 60% of the area of said first face;
a rigid spacer having a hardness greater than or equal to 90 Shore A according to standard ASTM D 2240-15(2021), placed between said first layer and the second electrochemical cell, the rigid spacer being located outside of the central region of said first layer.

On the one hand, the putting in place of a layer of a refractory material, in contact with the entirety of the face of largest area of one of the cells, makes it possible to create a thermal barrier preventing the propagation of thermal runaway from this cell to the neighboring cells.

On the other hand, the fact of disposing a rigid spacer outside the central region of the layer of refractory material can ensure that this central region is not compressed by the cells during their swelling and therefore that it retains its thermal barrier function.

According to one embodiment, the battery comprises a second layer of a refractory material able to withstand a temperature up to 1200° C., this second layer being disposed between the rigid spacer and the second electrochemical cell and being in contact with the entirety of a second face which is one of the faces of largest area of the second electrochemical cell, said second layer including a central region having as its center the center of said second layer and having an area representing 30 to 60% of the area of said second face.

According to one embodiment, the refractory material of the first layer and/or of the second layer is compressible such that its thickness can be reduced by at least 50% or by at least 70% or by at least 80% under the effect of a compression exerted by the two electrochemical cells.

According to one embodiment, the refractory material of the first layer and/or of the second layer is compressible such that its thickness can be reduced up to 95% under the effect of a compression exerted by the two electrochemical cells.

According to one embodiment, the refractory material of the first layer and/or of the second layer is a sheet comprising ceramic fibers.

According to one embodiment, the refractory material of the first layer and/or of the second layer has a thermal conductivity at 20° C. less than or equal to 0.5 W/(m·K).

According to one embodiment, the rigid spacer is composed of a plastic material that is chemically stable up to a temperature of 200° C.

According to one embodiment, the rigid spacer is made of a material chosen from the group consisting of the polytetrafluoroethylene (PTFE), polyimide (PI) and polyepoxide (PE).

According to one embodiment, the rigid spacer comprises four members forming a first rectangular frame.

According to one embodiment, the rigid spacer further comprises four other members forming a second rectangular frame of height and width greater than those of the first rectangular frame.

According to one embodiment,
the first layer and/or the second layer has a height and a width, and
the height and width of the second frame correspond to the height and width of the first layer and/or of the second layer.

According to one embodiment, the first and the second rectangular frames are rigidly linked by at least two connecting elements.

According to one embodiment, the battery comprises six connecting elements, two connecting elements each connecting a horizontal member of the first frame to a horizontal member of the second frame, and four connecting elements each connecting a corner of the first frame to a corner of the second frame.

According to one embodiment, the two ends of the connecting elements include reinforcements enabling the connection of the first frame to the second frame to be rigidified.

According to one embodiment, the thickness of a member ranges from 0.5 to 1.5 mm, preferably from 0.7 to 1 mm.

According to one embodiment, an assembly means makes it possible to rigidly link the first layer of refractory material with the rigid spacer.

According to one embodiment, an assembly means makes it possible to rigidly link the first layer of refractory material with the rigid spacer and with the second layer of refractory material.

The invention also relates to a method for assembling the battery as described above. Said method comprises the steps:
a) providing a first electrochemical cell of parallelepiped format,
b) putting in place a first layer of a refractory material able to withstand a temperature up to 1200° C., in contact with the entirety of a first face which is one of the faces of largest area of one of the electrochemical cells, said first layer including a central region having as its center the center of the first layer and an area representing 30 to 60% of the area of the first face;
c) putting in place a rigid spacer having a hardness greater than or equal to 90 Shore A according to standard ASTM D 2240-15(2021), against the first layer, the rigid spacer being located outside of the central region of said first layer;
d) attaching, against the rigid spacer, a second face which is one of the faces of largest area of the second electrochemical cell of parallelepiped format.

According to one embodiment, the method comprises, between step c) and step d), putting in place a second layer of a refractory material able to withstand a temperature up to 1200° C., said second layer including a central region having as its center the center of the second layer and an area representing 30 to 60% of the area of the second face, the second layer being in contact with the entirety of the second face.

According to one embodiment, the method comprises, after step d), a step of compressing said at least two electrochemical cells by means of a belt or a framework or a strap or a chassis around the cells.

### BRIEF DESCRIPTION OF THE DRAWINGS

Some embodiments of the invention are described in more detail below, with reference to the attached drawings.

FIG. 1 is a schematic sectional view of a battery comprising two electrochemical cells separated by a layer of a refractory material and a rigid spacer.

FIG. 2 is a schematic sectional view of a battery comprising two electrochemical cells separated by two layers of a refractory material and a rigid spacer, the rigid spacer being inserted between the two layers of refractory material.

FIG. 3 shows a view from above of an assembly composed of a layer of refractory material on which a rigid spacer is disposed.

### DESCRIPTION OF EMBODIMENTS OF THE INVENTION

The container of the cells is of parallelepiped format. It has six faces: an upper face, a lower face and four side faces. The lower face is that which is in contact with the support on which the cell rests. Two of the six faces are parallel and are the faces which have the largest area. The two faces having the largest area are generally those which are most subject to swelling. The two faces having the largest area are preferably oriented perpendicular to the support on which the cell rests.

A central region and a peripheral region are defined for the two faces of the container having the largest area. The central region undergoes more swelling than the peripheral region. The central region has, as its center, the center of the face considered, and extends over an area which represents 30 to 60% or 40 to 50% of the area of the face of the container. The peripheral region is the region extending beyond the central region.

The first layer of refractory material is disposed in contact with one of the faces of the container having the largest area. In general, the height and width of the first layer of refractory material correspond to the height and width of the face of largest area of the container. A central region and a peripheral region are defined for this first layer of refractory material. The central region has as its center the center of the first layer and extends over an area representing 30 to 60% or 40 to 50% of the area of the face of the container having the largest area. It is important that the central region of the layer of refractory material is not crushed under the effect of the compression of the cells. To this end, the rigid spacer is disposed outside of the central region of the layer of refractory material. The rigid spacer makes it possible to ensure there is no compression of the layer of refractory material in the central region. It can ensure that the thickness of the layer of refractory material is at least equal to a given thickness, which is equal to the thickness of the rigid spacer.

It is possible to use one, two or more layers of refractory material between the cells. The refractory material can be a highly compressible material, in other words under the effect of the compression its thickness can be reduced by at least 50% or by at least 70% or by at least 80%. Its thickness can be reduced by up to approximately 95%.

The refractory material is able to withstand a temperature ranging at least up to 1200° C. It can be a sheet comprising ceramic fibers, in other words artificial vitreous fibers (silicates) with random orientation and for which the percentage by weight of alkali metal oxides and alkaline earth oxides: [Na₂O]+[K₂O]+[CaO]+[MgO]+[BaO] is less than 18%. These fibers are made from mixtures of silica and alumina, or from kaolinite. Other oxides, such as zirconia, boron oxide or titanium oxide, can be added. The ceramic fibers are highly compressible. They therefore act as a spring. The thickness of the sheet comprising ceramic fibers thus adapts to the distance between two cells. The sheet comprising ceramic fibers compensates the small variations in dimensions of the cells which could arise during their manufacture. This makes it possible to use a single size of grouping box for the battery.

In addition to its property of resisting high temperatures, the refractory material can also have the property of being a good thermal insulator and preventing the heat generated by an abnormally functioning cell from propagating to the neighboring cells. The refractory material can have a thermal conductivity, at 20° C., less than 0.5 W/(m·K), preferably ranging from 0.02 to 0.2 W/(m·K).

The rigid spacer is composed of a material having a hardness greater than or equal to 90 Shore A according to standard ASTM D 2240-15(2021). Its rigidity makes it possible to maintain a constant spacing between two neighboring cells. In the absence of a rigid spacer, the swelling of two neighboring cells could lead to almost total crushing of the layer of refractory material over its entire height. The thickness of the layer of refractory material could, more specifically, represent not more than 5% of its thickness before compression. At such a low thickness, the layer of refractory material with almost no longer fulfil its thermal barrier function. Through the invention, the layer of refractory material is only reduced at the location of the rigid spacer, in other words only in the peripheral region. Since the layer of refractory material is in contact with practically the entirety of the height of the cell, it is possible to obtain a very effective thermal barrier.

The material composing the rigid spacer is preferably able to withstand a temperature of at least 200° C. It is preferably an electrically non-conductive material (such as plastic, for example). More preferably, it is polytetrafluoroethylene (PTFE), or polyimide (PI) or polyepoxide (PE). The thickness of the rigid spacer is not limited. It is chosen by an operator according to the desired spacing between the cells and the desired minimum thickness of the layer of refractory material. It can range from 0.5 to 1.5 mm, preferably from 0.7 to 1 mm. The use of a rigid spacer makes it possible to keep the refractory material uncompressed and to keep the spacing between two cells constant. Thus, the length of the battery does not vary during its operation. The invention can therefore respond to the dual requirement of providing, on the one hand, of a battery maintaining a constant length during its operation and, on the other hand, which prevents the propagation of thermal runaway between the battery cells.

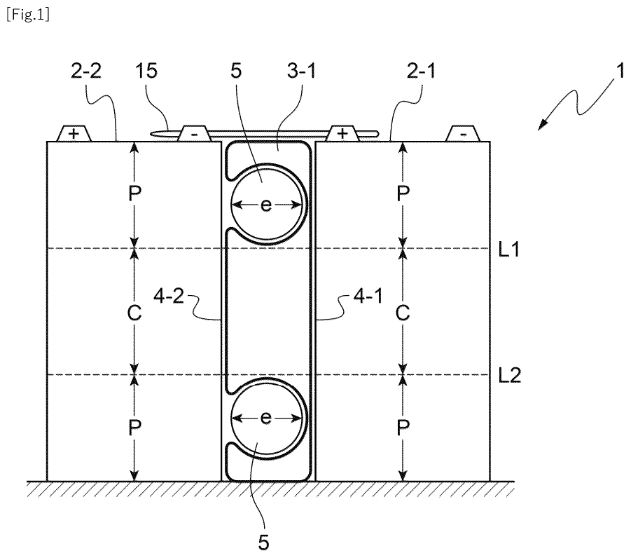

FIG. 1 schematically shows a first embodiment, in which a single layer of refractory material is used. It shows a battery (1) comprising two electrochemical cells (2-1, 2-2) of parallelepiped format. The container of these cells has an upper face including the positive and negative terminals, and a lower face, opposite the upper face, in contact with a support. The cells are electrically connected by a connecting part (15). A layer of refractory material (3-1) is disposed between the cells. In this example, the height of the layer of refractory material is identical to the height of the cells. One face of the layer of refractory material is in contact with one of the faces of largest area (4-1) of one of the cells (2-1). The contact takes place over the entire height of the layer of refractory material. The face opposite the layer of refractory material is not fully in contact with one of faces with the largest area (4-2) of the neighboring cell (2-2). More specifically, the presence of the rigid spacer (5) of thickness “e” does not allow the face opposite the layer of refractory material (3-1) to be fully in contact with the face of largest area (4-2) of the neighboring cell (2-2). The central region and the peripheral region are represented by the letters C and P respectively. The two limits L1 and L2 between the central region C and the peripheral region P of the containers of the two cells coincide with the limits between the central region and the peripheral region of the layer of refractory material. It should be noted that the rigid spacer is placed outside the central region. The layer of refractory material is therefore only compressed in its peripheral region which is the least subject to swelling. The layer of refractory material in its central region is not deformed.

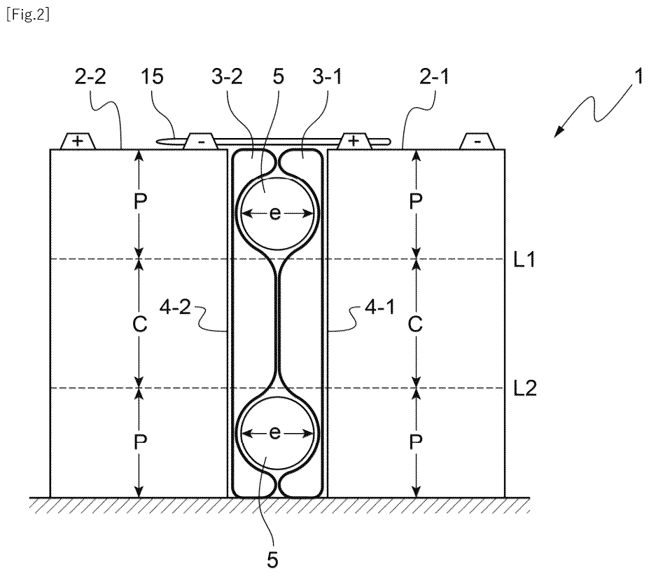

FIG. 2 schematically shows a second embodiment in which two layers (3-1, 3-2) of refractory material are disposed between two cells (2-1, 2-2). This second embodiment is preferable to the first because the two faces (4-1, 4-2) of the two cells which are facing one another are both fully in contact with a layer of refractory material. The thermal barrier effect is therefore improved.

The rigid spacer preferably has the form of a frame comprising two vertical members of height H1 and two horizontal members of length L1. The height H1 and the length L1 are determined such that the area of the frame is greater than the area of the central region of the layer of refractory material and therefore once in place between the cells, the rigid spacer is located outside the central region of the layer of refractory material.

In order to easily put in place the spacer between the cells during manufacture of the battery, the frame can be rigidly linked to a second frame of dimensions H2 and L2, greater than H1 and L1. Preferably, the second frame, the one or more layers of refractory material and the face of the container in contact with a layer of refractory material have the same height and width.

The first frame is rigidly linked to the second frame by connecting elements. When the second frame is placed between two electrochemical cells, it is aligned with the edge of the electrochemical cells. The first frame is automatically correctly placed outside the central region of the layer of refractory material.

The connecting elements connecting the first frame to the second frame can be six in number, two connecting elements each connecting a horizontal member of the first frame to a horizontal member of the second frame, and four connecting elements each connecting a corner of the first frame to a corner of the second frame.

The junction zone between a connecting element and a member of the first or second frame can be reinforced by locally enlarging the junction zone. This enlargement can be circular or rectangular in shape.

The assembly formed by the first frame, the second frame, the connecting elements and optionally the reinforcements can be manufactured by molding a plastic part. A single part is obtained which is easily manipulated and easy to position.

The rigid spacer can be incorporated in a layer of refractory material. It can also be sandwiched between two layers of refractory material. In the two cases, this makes it possible to have only a single part to manipulate during the assembly of the cells.

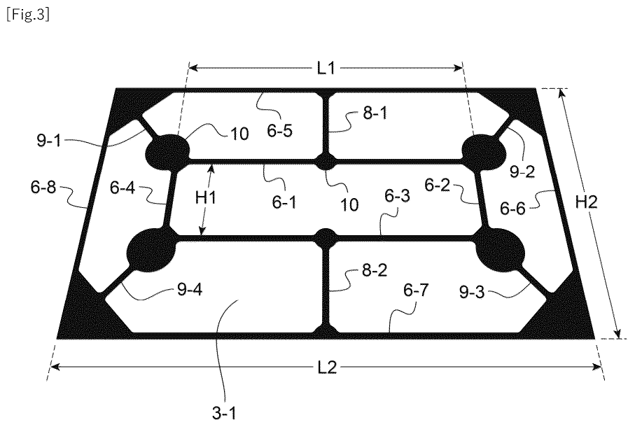

FIG. 3 is a view from above of an assembly composed of a layer of refractory material (3-1) on which a rigid spacer is disposed. The rigid spacer comprises a first frame comprising two horizontal members (6-1, 6-3) of length L1 and two vertical members (6-2, 6-4) of height H1. This first frame fits in a second frame of larger dimensions including two horizontal members (6-5, 6-7) of length L2 and two vertical members (6-6, 6-8) of height H2. The dimensions of the second frame correspond to the dimensions of the layer of refractory material which can itself be trimmed to the dimensions of the face of the cell with which it is in contact. The dimensions H1 and L1 of the first frame are calculated such that it is situated outside the central region of the layer of refractory material. The first frame is rigidly linked to the second frame using connecting elements. Two connecting elements (8-1, 8-2) each connect a horizontal member of the first frame to a horizontal member of the second frame. Four connecting elements (9-1, 9-2, 9-3, 9-4) each connect a corner of the first frame to a corner of the second frame. The ends of the connecting elements are provided with reinforcements (10) which consist of an enlargement of the junction zone between the members of the first or second frame and the connecting elements.

A method for assembling a battery comprising at least two electrochemical cells comprises the steps of:
a) providing a first electrochemical cell of parallelepiped format,
b) putting in place a first layer of a refractory material able to withstand a temperature up to 1200° C., in contact with the entirety of a first face which is one of the faces of largest area of one of the electrochemical cells, said first layer including a central region having as its center the center of the first layer and an area representing 30 to 60% of the area of the first face;
c) putting in place a rigid spacer having a hardness greater than or equal to 90 Shore A according to standard ASTM D 2240-15(2021), against the first layer, the rigid spacer being located outside the central region of said first layer;
d) attaching, against the rigid spacer, a second face which is one of the faces of largest area of the second electrochemical cell of parallelepiped format.

Preferably, before attaching the second electrochemical cell, a second layer of refractory material able to withstand a temperature up to 1200° C. is attached against the rigid spacer, said second layer including a central region having as its center the center of the second layer and an area representing 30 to 60% of the area of the second face in contact with the entirety of the second face of the second electrochemical cell.

In order to facilitate the putting in place of the rigid spacer, a rigid spacer composed of two frames of different dimensions rigidly linked to one another can be used, the frame of largest dimension having a height and a width identical to that of the layer of refractory material and to those of the face of the container of the cell, as shown in FIG. 3. This makes it possible to automatically position the rigid spacer correctly between the two cells.

Finally, the rigid spacer can be rigidly linked to one or more layers of refractory material in order to form an assembly placed in a single step between the two cells. One face of the layer or layers of refractory material can include an adhesive. One face of the rigid spacer can also include an adhesive. Another means consists of providing a clamp or a clip disposed on the outer frame of the rigid spacer and which holds the layer or layers of refractory material.

1. A battery comprising:
at least two electrochemical cells of parallelepiped format;
a first layer of a refractory material able to withstand a temperature up to 1200° C. disposed in contact with the entirety of a first face which is one of the faces of largest area of one of the electrochemical cells, said first layer comprising a central region having as its center the center of the first layer and having an area representing 30 to 60% of the area of said first face; and
a rigid spacer having a hardness greater than or equal to 90 Shore A according to standard ASTM D 2240-15(2021), placed between said first layer and the second electrochemical cell, the rigid spacer being located outside of the central region of said first layer.

2. The battery according to claim 1, further comprising a second layer of a refractory material able to withstand a temperature up to 1200° C., this second layer being disposed between the rigid spacer and the second electrochemical cell and being in contact with the entirety of a second face which is one of the faces of largest area of the second electrochemical cell, said second layer including a central region having as its center the center of said second layer and having an area representing 30 to 60% of the area of said second face.

3. The battery according to claim 1, wherein the refractory material of the first layer and/or of the second layer is compressible such that its thickness can be reduced by at least 50% or at least 70% or at least 80% under the effect of a compression exerted by the two electrochemical cells.

4. The battery according to claim 1, wherein the refractory material of the first layer and/or of the second layer is compressible such that its thickness can be reduced up to 95% under the effect of a compression exerted by the two electrochemical cells.

5. The battery according to claim 1, wherein the refractory material of the first layer and/or of the second layer is a sheet comprising ceramic fibers.

6. The battery according to claim 1, wherein the refractory material of the first layer and/or of the second layer has a thermal conductivity at 20° C. less than or equal to 0.5 W/(m·K).

7. The battery according to claim 1, wherein the rigid spacer is composed of a plastic material that is chemically stable up to a temperature of 200° C.

8. The battery according to claim 7, wherein the rigid spacer is made of a material chosen from the group consisting of polytetrafluoroethylene, polyimide and polyepoxide.

9. The battery according to claim 1, wherein the rigid spacer comprises four members forming a first rectangular frame.

10. The battery according to claim 9, wherein the rigid spacer further comprises four other members forming a second rectangular frame of height and width greater than those of the first rectangular frame.

11. The battery according to claim 10, wherein:
the first layer and/or the second layer has a height and a width, and
the height and the width of the second frame correspond to the height and width of the first layer and/or of the second layer.

12. The battery according to claim 10, wherein the first and second rectangular frame are rigidly linked by at least two connecting elements.

13. The battery according to claim 12, comprising six connecting elements, two connecting elements each connecting a horizontal member of the first frame to a horizontal member of the second frame, and four connecting elements each connecting a corner of the first frame to a corner of the second frame.

14. The battery according to claim 12, wherein the two ends of the connecting elements include reinforcements enabling the connection of the first frame to the second frame to be rigidified.

15. The battery according to claim 9, wherein the thickness of a member ranges from 0.5 to 1.5 mm, preferably from 0.7 to 1 mm.

16. The battery according to claim 9, wherein an assembly means makes it possible to rigidly link the first layer of refractory material with the rigid spacer.

17. The battery according to claim 2, wherein an assembly means makes it possible to rigidly link the first layer of refractory material with the rigid spacer and with the second layer of refractory material.

18. A method for assembling a battery comprising at least two electrochemical cells, said method comprising the steps of:
a) providing a first electrochemical cell of parallelepiped format,
b) putting in place a first layer of a refractory material able to withstand a temperature up to 1200° C., in contact with the entirety of a first face which is one of the faces of largest area of one of the electrochemical cells, said first layer including a central region having as its center the center of the first layer and an area representing 30 to 60% of the area of the first face;
c) putting in place a rigid spacer having a hardness greater than or equal to 90 Shore A according to standard ASTM D 2240-15(2021), against the first layer, the rigid spacer being located outside of the central region of said first layer;
d) attaching, against the rigid spacer, a second face which is one of the faces of largest area of the second electrochemical cell of parallelepiped format.

19. The method according to claim 18 comprising, between step c) and step d), the putting in place of a second layer of a refractory material able to withstand a temperature up to 1200° C., said second layer including a central region having as its center the center of the second layer and an area representing 30 to 60% of the area of the second face, the second layer being in contact with the entirety of the second face.

20. The method according to claim 18, comprising, after step d), a step of compressing said at least two electrochemical cells by means of a belt or a framework or a strap or a chassis around the cells.
